(19) United States
(12) Patent Application Publication
(10) Pub. No.: US 2025/0344141 A1
(43) Pub. Date: Nov. 6, 2025

(54) COMMUNICATION METHOD AND DEVICE USING NETWORK SLICING

(71) Applicant: Samsung Electronics Co., Ltd., Suwon-si, Gyeonggi-do (KR)

(72) Inventor: Kyungjoo SUH, Suwon-si (KR)

(21) Appl. No.: 18/862,338

(22) PCT Filed: May 2, 2023
(86) PCT No.: PCT/KR2023/005984

§ 371 Date: Nov. 1, 2024

(30) Foreign Application Priority Data
May 2, 2022 (KR) 10-2022-0054485

(51) Int. Cl. H04W 48/18; H04W 60/04; H04W 76/20

(52) U.S. Cl. CPC H04W 48/18; H04W 60/04; H04W 76/20

(57) ABSTRACT

The present disclosure relates to a 5G or 6G communication system for supporting a higher data transmission rate. The present disclosure relates to a communication method by a terminal using network slicing. The method may comprise the operations of: transmitting a first non-access stratum (NAS) message to a network entity; receiving, from the network entity, a second NAS message including slicing-related information related to a slice group and a slice priority; and selecting a radio access network (RAN) slice in an AS layer by using the slicing-related information.

### CROSS-REFERENCE TO RELATED APPLICATION(S)

This application is a U.S. National Stage application under 35 U.S.C. § 371 of an International application number PCT/KR2023/005984, filed on May 2, 2023, which is based on and claims priority of a Korean patent application number 10-2022-0054485, filed on May 2, 2022, in the Korean Intellectual Property Office, the disclosure of which is incorporated by reference herein in its entirety.

### TECHNICAL FIELD

The disclosure relates to a method and device for supporting network slicing in a wireless communication system.

### BACKGROUND ART

5G mobile communication technology defines a wide frequency band to enable fast transmission speed and new services and may be implemented in frequencies below 6 GHZ (‘sub 6 GHz’), such as 3.5 GHZ, as well as in ultra-high frequency bands (‘above 6 GHz’), such as 28 GHz and 39 GHz called millimeter wave (mm Wave). Further, 6G mobile communication technology, which is called a beyond 5G system, is considered to be implemented in terahertz bands (e.g., 95 GHz to 3 THz) to achieve a transmission speed 50 times faster than 5G mobile communication technology and ultra-low latency reduced by 1/10.

In the early stage of 5G mobile communication technology, standardization was conducted on beamforming and massive MIMO for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, L2 pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the VoNR, new radio unlicensed (NR-U) aiming at the system operation matching various regulatory requirements, NR UE power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step RACH for NR to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, soaring connected devices would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and artificial intelligence (AI) from the step of design, and next-generation distributed computing technology for implementing services with complexity beyond the limit of the UE operation capability by way of ultrahigh performance communication and computing resources.

### DETAILED DESCRIPTION OF THE INVENTION

### Technical Problem

Embodiments of the disclosure may provide a device and method for supporting network slicing in a wireless communication system.

Embodiments of the disclosure may provide a method and device for operating a user equipment (UE) and a network to provide network slicing.

Objects of the disclosure are not limited to the foregoing, and other unmentioned objects would be apparent to one of ordinary skill in the art from the following description.

### Technical Solution

According to an embodiment of the disclosure, a method for communication by a user equipment (UE) using network slicing may comprise transmitting a first non-access stratum (NAS) message to a network entity, receiving, from the network entity, a second NAS message including slicing-related information related to a slice priority and an access stratum (AS) slice group, and selecting a radio access network (RAN) slice in an AS layer using the slicing-related information.

According to an embodiment of the disclosure, a method for communication by a network entity using network slicing may comprise receiving a first non-access stratum (NAS) message from a user equipment (UE), and transmitting, to the UE, a second non-access stratum (NAS) message including slicing-related information related to a slice priority and an access stratum (AS) slice group. The slicing-related information may be used for the UE to select a radio access network (RAN) slice in an AS layer.

According to an embodiment of the disclosure, a device of a user equipment (UE) that communicates using network slicing may comprise a transceiver and a processor. The processor may be configured to transmit a first NAS message to a network entity, receive, from the network entity, a second NAS message including network slice selection assistance information (NSSAI) and slicing-related information related to an access stratum (AS) slice group and a slice priority, and select a RAN slice in an AS layer using the slicing-related information.

### BRIEF DESCRIPTION OF THE DRAWINGS

FIG. 1 illustrates a 5G network environment according to an embodiment of the disclosure;

FIG. 2 is a flowchart illustrating a registration procedure of supporting a network slice in a 5G network environment according to an embodiment of the disclosure;

FIG. 3 is a flowchart illustrating a registration procedure of supporting a network slice in a 5G network environment according to an embodiment of the disclosure;

FIG. 4 is a flowchart illustrating a network slice procedure of supporting a network slice in a 5G network environment according to an embodiment of the disclosure;

FIG. 5 is a flowchart illustrating a network slice procedure of supporting a network slice in a 5G network environment according to an embodiment of the disclosure;

FIG. 6 is a flowchart illustrating a deregistration procedure of supporting a network slice in a 5G network environment according to an embodiment of the disclosure;

FIG. 7 is a flowchart illustrating a NAS transport procedure of supporting a network slice in a 5G network environment according to an embodiment of the disclosure;

FIG. 8 is a view illustrating a configuration of a UE according to an embodiment; and

FIG. 9 is a block diagram illustrating a configuration of a network entity according to an embodiment.

### MODE FOR CARRYING OUT THE INVENTION

Hereinafter, embodiments of the disclosure are described in detail with reference to the accompanying drawings. In describing embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments, a “ . . . unit” may include one or more processors.

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

For ease of description, the terms and names defined in the 3rd generation partnership project long term evolution (3GPP LTE) standards, or terms and names modified based thereupon may be used herein. However, the disclosure is not limited by such terms and names and may be likewise applicable to systems conforming to other standards. In the disclosure, eNB may be used interchangeably with gNB for convenience of description. In other words, the base station described as an eNB may represent a gNB. The term UE herein may refer to mobile phones, NB-IoT devices, sensors, as well as other wireless communication devices.

The description of embodiments of the disclosure focuses primarily on 3GPP communication standards, but the subject matter of the disclosure may also be applicable to other communication systems with a similar technical background with minor changes without significantly departing from the scope of the present invention, and this may be so performed by the determination of those skilled in the art to which the disclosure pertains.

In 5G or NR systems, the access and mobility management function (AMF) which is a manager entity for managing the mobility of the UE and the session management function (SMF) which is an entity for managing the session are separated. Accordingly, unlike in the 4G LTE communication system, where the mobility management entity (MME) performs both mobility management and session management, in the 5G or NR system, an entity performing mobility management and an entity performing session management are separated, respectively, so that the communication method and communication management method between the UE and the network entity may be changed.

For non 3GPP access in the 5G or NR system, mobility management and session management, respectively, are performed through the AMF and the SMF, via the non-3GPP inter-working function (N3IWF). Further, security-related information which is a critical factor in mobility management is processed through the AMF.

As described above, in the 4G LTE system, the MME is in charge of mobility management and session management. The 5G or NR system may support a non-standalone architecture that performs communication using the network entities of the 4G LTE system together.

In a 5G or NR system, when slicing-related information (e.g., at least one of RAN slicing information, network slice group information, or slice priority information about a RAN slice) is provided from the network to the UE, slicing-related information transferred through the non-access stratum (NAS) layer and slicing-related information processed through the access stratum (AS) layer may be mismatched. As an example, the above problem may occur when the UE moves from a network capable of handling slicing-related information such as RAN slicing information, slice group information, or slice priority information to a network incapable of handling slicing-related information. As an example, the above problem may also occur when the UE moves from a network capable of handling slicing-related information such as RAN slicing information, slice group information, or slice priority information to a network capable of handling slicing-related information.

Embodiments of the disclosure may address an information mismatch that may occur when the 5G network supports RAN slicing or core network slicing or the network sends, to the UE, the slice group information and/or slice priority information in an environment of supporting RAN slicing or network slicing.

Embodiments of the disclosure may enhance network communication performance through making protocol efficient and may efficiently perform communication.

Embodiments of the disclosure may enable efficient communication by well processing network slicing-related information when the UE performs communication with a network entity when the wireless communication system supports network slice, e.g., when the NR base station supports network slicing or RAN slicing or when the core network supports the features of RAN slicing.

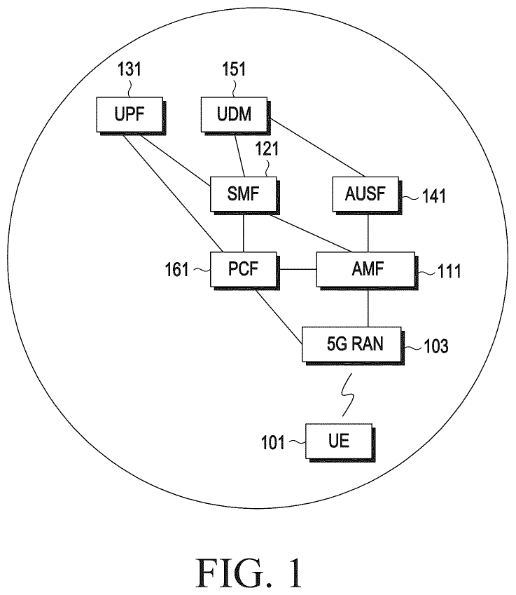

FIG. 1 illustrates a 5G network environment according to an embodiment of the disclosure.

Referring to FIG. 1, a 5G or NR core network may include at least one network function (NF) such as a user plane function (UPF) 131, a session management function (SMF) 121, an access and mobility management function (AMF) 111, a 5G radio access network (RAN) 103, a user data management (UDM) 151, and a policy control function (PCF) 161. Network entities such as an authentication server function (AUSF) 141 or an authentication-authorization-and-accounting server (AAA) 171 may be further included for authenticating the network entities. The UE 101-1 may access a 5G core network through a base station (BS) 103 (e.g., a 5G radio access network (RAN)).

In an embodiment, an N3 interworking function (N3IWF) may be used for a case where the UE communicates through non-3GPP access. When non-3GPP access is used, session management may be controlled through the UE, non-3GPP access, N3IWF, and SMF, and mobility management may be controlled through the UE, non-3GPP access, N3IWF, and AMF.

In the 5G or NR system, mobility management and session management are separated into the AMF 111 and the SMF 121, respectively.

With regard to deployment of a 5G or NR system, a standalone deployment structure using only 5G or NR entities (hereinafter referred to as 5G/NR entities) and a non-standalone deployment structure using both 4G entities and 5G/NR entities are considered.

Referring to FIG. 1, when the UE 101 communicates with the network (e.g., the network entity of the 5G core network), such the form of deployment may be possible in which control is performed by the eNB (e.g., the 5G RAN) 103, and 5G entities of the core network (e.g., the AMF 111, the SMF 121, the PCF 161, the AUSF 141, the UDM 151, and/or the UPF 101) are used. In this case, mobility management between the UE 110 and the AMF 111 and session management between the UE 101 and the SMF 121 may be performed in a non-access stratum (NAS) layer which is layer 3.

Embodiments of the disclosure are based on the network of 5G or 4G LTE, but may be applied when the same concept is applied to other systems within a category that may be understood by one of ordinary skill in the art.

In embodiments described below, slicing-related information (e.g., slice group and/or slice priority information) related to the network slice and/or the RAN slice may be transferred between the UE (e.g., the UE 101) and the network. Embodiments described below may prevent information mismatch between layers of the network or the UE when transferring slicing-related information.

In an embodiment, the slicing-related information (e.g., slice group information and/or slice priority information) may be transferred from the network entity to the UE together with network slice selection assistance information (NSSAI) through a NAS message. The slicing-related information may include at least one of configured NSSAI, allowed NSSAI, or newly defined allowed group slice information. The NAS message may include at least one of a registration accept message, a configuration command message, or a service request message.

In an embodiment, the slicing-related information (e.g., slice group information and/or slice priority information) may be transferred from the network to the UE through the AS layer. In method 2, the slicing-related information may be transferred from the NAS layer to a lower layer, i.e., the AS layer.

In an embodiment, the AS layer of the UE may select a RAN slice based on slicing-related information (e.g., slice group information and/or slice priority information).

In an embodiment, when the slicing-related information (e.g., slice group information and/or slice priority information) received by the UE does not match the slicing-related information previously stored by the UE, the UE may store the AS slice group and/or slice priority indicated by the received slicing-related information in not-allowed slice information.

In an embodiment, the network may inform the UE whether the network supports a function related to slice group and/or slice priority. When the function is not supported, the UE may communicate with the network using information such as configured NSSAI or allowed NSSAI.

In an embodiment, the function of the network may be indicated to the UE using a 5GS network feature support information element (IE). The function of the network may be indicated to the UE using the slice group support indication in an embodiment.

In an embodiment, the UE may inform the network entity whether the UE supports a function related to slice group and/or slice priority. When the UE receives information indicating that the function is not supported, the network may not provide the function to the UE even if the function is supported.

According to an embodiment, the function of the UE may be reported to the network using the slice group support indication IE in an embodiment. The function of the UE may be reported to the network using 5GMM capability information IE. The 5GMM capability information IE may indicate whether AS slice network slicing is supported, and for example, the UE may transfer the 5GMM capability information IE together with slice priority information to the network.

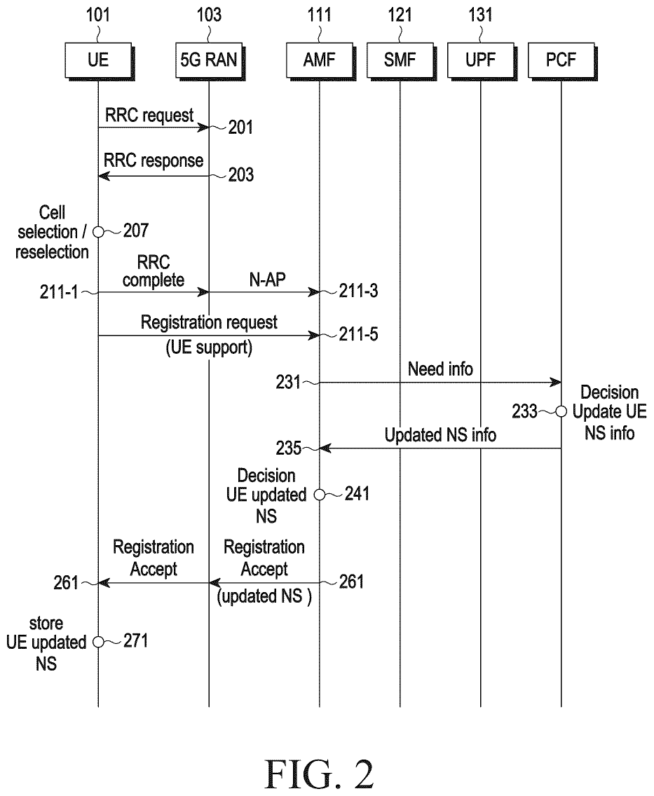

FIG. 2 is a flowchart illustrating a registration procedure of supporting a network slice in a 5G network environment according to an embodiment of the disclosure. In various embodiments, at least one of operations (e.g., steps) to be described below may be omitted, modified, or reordered.

Referring to FIG. 2, in step 201, the UE (e.g., the UE 101) may send a request message (e.g., an RRC request) for requesting establishment of an RRC connection to the 5G RAN (e.g., the 5G RAN 103).

In step 203, the 5G RAN may send a response message (e.g., RRC response) to the UE. In an embodiment, slicing-related information (e.g., slice group information and/or slice priority information) may be transferred through the response message of the AS layer. In an embodiment, the UE may verify the slicing-related information.

In step 207, the UE may perform cell selection or cell reselection using the slicing-related information. In an embodiment, the AS layer of the UE may select a RAN slice based on the slicing-related information. In an embodiment, the slicing-related information may include at least one of slice group information, slice priority information, or tracking area code.

In step 211-1, the UE may send a completion message (e.g., RRC complete) to the 5G RAN.

In step 211-3, the 5G RAN may send an N-AP message to the AMF (e.g., the AMF 111).

In step 211-5, the UE may send a registration request message to the AMF. In an embodiment, the registration request message may include an indication of at least one of whether the UE supports RAN slicing, whether the UE supports a RAN slicing group (e.g., a slice group), whether the UE requests RAN slicing priority (e.g., a slice priority), or whether the UE supports a function of transferring the slicing-related information.

In an embodiment, the slicing-related information (e.g., slice group information and/or slice priority information) may be transferred from the network entity to the UE together with the NSSAI through the NAS message.

In an embodiment, the slicing-related information may include at least one of configured NSSAI, allowed NSSAI, or allowed group slice information. The NAS message may be a registration accept message of step 261 in an embodiment. The NAS message may be a configuration command message in an embodiment. The NAS message may be a service request message in an embodiment.

In an embodiment, the slicing-related information may be transferred to a lower layer (e.g., an AS layer) by the NAS layer of the UE.

In an embodiment, when the slicing-related information received by the UE does not match the previously stored slicing-related information, the UE may store a slice group and/or a slice priority indicated by the slicing-related information in the not-allowed slice information.

In an embodiment, the UE may inform the network entity of information about whether the UE supports a function related to slice group and/or slice priority. When the UE receives information about not supporting the function, the network may not provide the function to the UE even if the function is supported.

In an embodiment, the UE may transmit, to the network (e.g., the AMF or the SMF), whether to support the function using the slice group support indication IE. In an embodiment, the UE may transfer the slice priority information and the information indicating whether to support the slice group to the network using the 5GMM capability information IE.

In step 231, the AMF may request, from the PCF, network slice (NS) information about at least one of RAN slicing, network slicing, slice group, or priority related to the UE.

In step 233, the PCF may determine (e.g., update) NS information indicating a policy for at least one of RAN slicing, network slicing, slice group, or priority in relation to the UE.

In step 235, the PCF may transmit NS information indicating a policy for at least one of RAN slicing, network slicing, slice group, or priority for the UE to the AMF. Through the policy, the AMF may update its own NS information about at least one of RAN slicing, network slicing, slice group, or priority that it has for UE. In an embodiment, since it is the AMF which applies the policy to the UE, the AMF may determine whether to apply the policy to the UE (e.g., whether to update the network slice of the UE) as in step 241.

In step 241, the AMF may make a decision on whether to update the network slice of the UE.

In step 261, the AMF may transmit a registration accept message to the UE.

The registration accept message may include slicing-related information (e.g., updated NS information) related to at least one of RAN slicing, network slicing, slice group, or priority for the UE received by the AMF from the PCF. In an embodiment, the AMF may transmit slicing-related information related to the network slice(s) determined by the network entity (e.g., the AMF) or allowed by the network entity (e.g., the AMF) to the UE for at least one of the RAN slicing, the network slicing, the slice group, or the priority requested by the UE. In an embodiment, the AMF may transmit information (e.g., an IE, a parameter, or an indication) about whether the AMF supports a function for at least one of RAN slicing, network slicing, slice group, or priority to the UE through the registration accept message.

In an embodiment, the network entity (e.g., AMF) may inform the UE of information related to whether the network entity supports the function related to the slice group and/or the slice priority. When the function is not supported, the UE may operate using configured NSSAI or allowed NSSAI.

The information about the function of the network may be provided to the UE using a 5GS network feature support information element (IE) in an embodiment. In an embodiment, the function of the network may be provided to the UE using the slice group support indication IE.

Upon receiving, from the network entity, information about at least one of RAN slicing, network slicing, slice group, or priority and information (e.g., an IE or indicator) about whether the network supports the function, the UE may store the information or update the information in step 271.

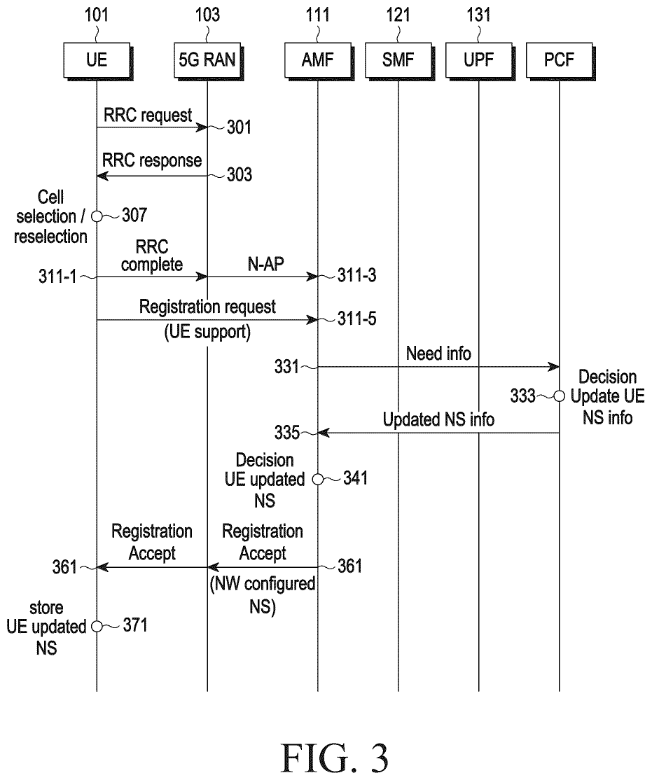

FIG. 3 is a flowchart illustrating a registration procedure of supporting a network slice in a 5G network environment according to an embodiment of the disclosure. In various embodiments, at least one of operations (e.g., steps) to be described below may be omitted, modified, or reordered.

Referring to FIG. 3, in step 301, the UE (e.g., the UE 101) may send an RRC request to a 5G RAN (e.g., the 5G RAN 103).

In step 303, the 5G RAN may send an RRC response to the UE. In an embodiment, slicing-related information (e.g., slice group information and/or slice priority information) may be transferred through the RRC response message of the AS layer.

Thereafter, the UE may verify the slicing-related information.

In an embodiment, when the slicing-related information received by the UE does not match the previously stored slicing-related information, the UE may store the slice group and/or slice priority indicated by the received slicing-related information in the not-allowed slice information.

In step 307, the UE may perform cell selection or cell reselection based on the slicing-related information.

In step 311-1, the UE may send an RRC complete to the 5G RAN.

In step 311-3, the 5G RAN may send an N1-AP message to an AMF (e.g., the AMF 111).

In step 311-5, the UE may send a registration request to the AMF. In an embodiment, the registration request message may include at least one of indication about whether the UE supports RAN slicing, whether the UE supports the RAN slicing group, whether the UE requests priority in the RAN slicing, or whether the UE supports the above-described function and be transferred to the AMF.

In an embodiment, the slicing-related information (e.g., slice group information and/or slice priority information) may be transferred from the network entity to the UE together with the NSSAI through the NAS message. The slicing-related information may include at least one of configured NSSAI, allowed NSSAI, or allowed group slice information. The NAS message may be the registration accept message of step 361 in an embodiment. The NAS message may be a configuration command message in an embodiment. The NAS message may be a service request message in an embodiment.

In an embodiment, the slicing-related information may be transferred to the lower layer, i.e., the AS layer, by the NAS layer of the UE.

In an embodiment, the AS layer of the UE may select a RAN slice based on the slicing-related information.

In an embodiment, when the slicing-related information received by the UE does not match the previously stored slicing-related information, the UE may store a slice group and/or a slice priority indicated by the slicing-related information in the not-allowed slice information.

In an embodiment, the UE may inform the network whether the UE supports a function related to AS slice group and/or slice priority. When the UE receives information about not supporting the function, the network may not provide the function to the UE even if the function is supported.

In an embodiment, the UE may transmit, to the network (e.g., the AMF or the SMF), whether to support the function using the slice group support indication IE. In an embodiment, the UE may transfer the priority information together with whether to support the AS slice network slicing, to the network using the 5GMM capability information IE.

Thereafter, the AMF may verify the information received from the UE.

In step 331, the AMF may request, from the PCF, at least one of RAN slicing information, network slicing information, slice group information, or priority information related to the UE.

In step 333, the PCF may determine a policy for RAN slicing, network slicing, slice group, or priority in relation to the UE.

In step 335, the PCF may transmit policy information for at least one of RAN slicing, network slicing, slice group, or priority for the UE to the AMF. Through the policy information, the AMF may update information about at least one of RAN slicing, network slicing, slice group, or priority that it has for UE. In an embodiment, since it is the AMF which applies the policy to the UE, the AMF may determine whether to apply the policy to the UE (e.g., whether to update the network slice of the UE) as in step 341.

In step 341, the AMF may make a decision on whether to update the network slice of the UE.

In step 361, the AMF may transmit a registration accept message to the UE.

The registration accept message may carry slicing-related information related to at least one of RAN slicing, network slicing, slice group, or priority for the UE received by the AMF from the PCF. In an embodiment, information about the network slice configured by the network for the UE among network slices requested by the UE may be included in the registration accept message.

In an embodiment, the network entity (e.g., AMF) may inform the UE of information about whether the network supports the function related to the slice group and/or slice priority. When the function is not supported, the UE may operate using configured NSSAI or allowed NSSAI.

The information about the function of the network entity (e.g., AMF) may be provided to the UE using, e.g., the 5GS network feature support IE in an embodiment. The function of the network may be provided to the UE using the slice group support indication in an embodiment.

Upon receiving, from the network entity, information about at least one of RAN slicing, network slicing, slice group, or priority and information (e.g., an IE or indicator) about whether the network supports the function, the UE may store the information or update the information in step 371.

In an embodiment, the slice group may include grouped slices. Slice grouping may be done according to the operator's policy.

In an embodiment, the operator's policy may give higher priority to the user who pays higher usage fees, based on the usage fees paid by the users. For example, when 1 has the highest priority in the order of 1, 2, and 3, the slice group having the high priority may be assigned priority 1.

In an embodiment, slice types corresponding to URLLC or eMBB may be classified according to the operator's policy, and differential priorities may be set according to the slice types.

In an embodiment, when URLLC slices are grouped, the high priority may be given to the slice whose reliability is temporally a priority.

In an embodiment, when the short latency is critical, a high priority may be given to the slice of the short latency.

In an embodiment, if a higher priority is given to the one requiring a large amount of data when grouping the eMBB slices, a high priority may be given to the group of the slices.

In an embodiment, the operation of grouping network slices may be performed by the AMF. In other words, the AMF may group the allowed NSSAI(s), the configured NSSAI(s), and/or the rejected NSSAI(s), generate allowed slice group information, configured slice group information, and/or rejected slice group information, based on the S-NSSAI information and the operator policy received from the gNB, and transmit the generated information to the UE.

In an embodiment, the operation of grouping network slices may be performed by the gNB. In other words, the gNB may create an allowed slice group based on allowed slice information (e.g., allowed NSSAI(s)) received from the AMF.

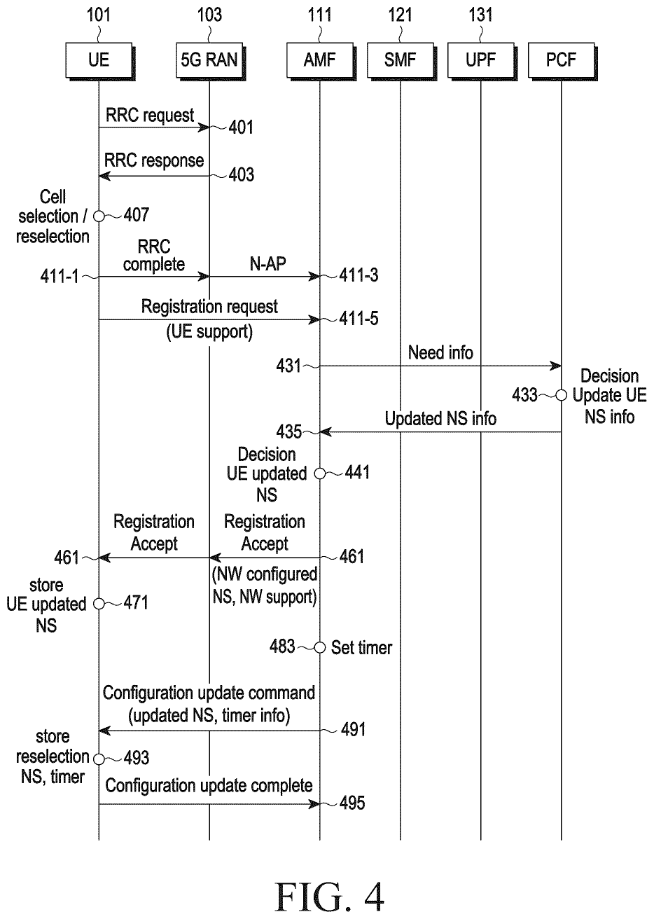

FIG. 4 is a flowchart illustrating a procedure of efficiently supporting a network slice in a 5G network environment according to an embodiment of the disclosure. In various embodiments, at least one of operations (e.g., steps) to be described below may be omitted, modified, or reordered.

Referring to FIG. 4, in step 401, the UE (e.g., the UE 101) may send an RRC request to a 5G RAN (e.g., the 5G RAN 103).

In step 403, the 5G RAN may send an RRC response to the UE. In an embodiment, slicing-related information (e.g., slice group information and/or slice priority information) may be carried through the RRC response message of the AS layer.

In step 407, the UE may perform cell selection or cell reselection based on the slicing-related information.

If the UE previously connects to the network and receives slice group/slice priority information through a NAS message, the information may be used for cell reselection of the AS layer. (e.g., process 461 of FIG. 4)

In an embodiment, slice group/slice priority information stored in the UE through the NAS message may be used as follows.

The information may be used to reselect a suitable cell to be accessed by the UE in the AS layer. In other words, when both the network and the UE support a slice group and there are a slice group priority and a slice group priority, the UE makes the selection with priority to the cell having high slice group priority based on the corresponding information, in cell reselection and cell search.

In an embodiment, when the UE has a PDU session as it is performing communication, the information may be used to configure slice group information in a UL NAS transport message used to transmit a session management message to the NAS layer.

In an embodiment, the information may be used to select a requested slice group when the UE transmits a registration request message or the UE transmits a service request message.

In step 411-1, the UE may send an RRC complete to the 5G RAN.

In step 411-3, the 5G RAN may send an NG-AP message to an AMF (e.g., the AMF 111).

In step 411-5, the UE may send a registration request to the AMF. In an embodiment, the registration request message may include at least one of indication about whether the UE supports RAN slicing, whether the UE supports the RAN slicing group, whether the UE requests priority in the RAN slicing, or whether the UE supports the above-described function and be transferred to the AMF.

In an embodiment, the slicing-related information (e.g., slice group information and/or slice priority information) may be transferred from the network entity to the UE together with the NSSAI through the NAS message.

The slicing-related information may include at least one of configured NSSAI, allowed NSSAI, or allowed group slice information. The NAS message may be the registration accept message of step 461 in an embodiment. The NAS message may be a configuration command message in an embodiment. The NAS message may be a service request message in an embodiment.

In an embodiment, the slicing-related information may be transferred to the lower layer, i.e., the AS layer, by the NAS layer of the UE.

In an embodiment, the AS layer of the UE may select a RAN slice based on the slicing-related information.

In an embodiment, when the slicing-related information received by the UE does not match the previously stored slicing-related information, the UE may store a slice group and/or a slice priority indicated by the slicing-related information in the not-allowed slice information.

In an embodiment, the UE may inform the network entity of information about whether the UE supports a function related to slice group and/or slice priority. When the UE receives information about not supporting the function, the network entity may not provide the function to the UE even if the function is supported.

In an embodiment, the UE may transmit, to the network (e.g., the AMF or the SMF), whether to support the function using the slice group support indication IE. In an embodiment, the UE may transfer the priority information together with whether to support the AS slice network slicing, to the network using the 5GMM capability information IE.

In an embodiment, slice group information may be included in the registration request message.

The slice group information according to an embodiment may include at least one of the tracking area code (TAC), the slice group identity, slice information (e.g., NSSAI), or slice priority. In this case, the identities of the slice group may be mapped to one TAC. Further, slice priority may be mapped to slice group.

In an embodiment, information about the slices may be grouped and mapped to the slice group identity.

For reference, slices may be identified by network slice selection assistance information (NSSAI). In other words, the single-network slice selection assistance information (S-NSSAI) is used as an identifier for distinguishing slices, and slice-related information includes a slice type (e.g., SST) and a slice differentiator (e.g., SD). The slice type may be used to distinguish whether slice supports eMBB or URLLC. The slice differentiator may be used to further subdivide the slice compared to slice type. For example, for URLLC, the slice differentiator may distinguish whether the slice is for the surgical robot or for factory automation.

In an embodiment, the IE, slice group information, may include at least one of TAC, slice group identity, NSSAI, or slice priority.

In an embodiment, the slice group information may include the following information.

In an embodiment, the slice group information may include requested slice group information. In this case, the NSSAI may be a requested NSSAI. The UE may select a requested NSSAI from a configured NSSAI or an allowed NSSAI. In this case, the slice group information may be the requested slice group IE. Therefore, the UE may select the requested slice group from the configured slice group or the allowed slice group.

In an embodiment, the requested slice group information may be transferred through a registration request message or a service request message.

In an embodiment, if the UE previously connects to the network and receives slice group/slice priority information through a NAS message, the requested slice group information may be used for cell reselection of the AS layer.

In an embodiment, the slice group and/or slice priority information transferred to the UE through the NAS message may be used as follows.

In an embodiment, the information may be used to reselect a suitable cell to be accessed by the UE in the AS layer. In other words, when both the network and the UE support a slice group and there are a slice group priority and a slice group priority, the UE makes the selection with priority to the cell having high slice group priority based on the corresponding information, in cell reselection and cell search.

In an embodiment, when the UE has a PDU session as it is performing communication, the information may be used to configure slice group information in a UL NAS transport message used to transmit a session management message to the NAS layer.

In an embodiment, the information may be used to select a requested slice group when the UE transmits a registration request message or the UE transmits a service request message.

In an embodiment, when the network has slice group and priority information about the UE, the network (e.g., the AMF) may send a deregistration request message to attempt to delete the slice group information stored in the UE.

In an embodiment, when the slice group information and/or the slice priority information expires, is deleted, or is absent, the UE may request the slice group information and/or the slice priority information from the network.

In an embodiment, the UE may request slice group information and/or slice priority information even when the registration area is changed or the tracking area is changed.

The information for the request may include the ‘slice group information requested’ IE.

In an embodiment, the UE may set at least one bit of the IE to “1” for “slice group information requested” and may transmit the same to the network entity. For the UE capable of supporting the slice group, the at least one bit may be ‘1’ by default.

In an embodiment, the message for transferring the ‘slice group information requested’ IE may be a registration request message. In an embodiment, the message for transferring the ‘slice group information requested’ IE may be a service request message.

Thereafter, the AMF may verify the information received from the UE.

In step 431, the AMF may request, from the PCF, at least one of RAN slicing information, network slicing information, slice group information, or priority information related to the UE.

In step 433, the PCF may determine a policy for at least one of RAN slicing, network slicing, slice group, or priority in relation to the UE.

In step 435, the PCF may transmit policy information for at least one of RAN slicing, network slicing, slice group, or priority for the UE to the AMF. Through the policy information, the AMF may update information about at least one of RAN slicing, network slicing, slice group, or priority that it has for UE. In an embodiment, since it is the AMF which applies the policy to the UE, the AMF may determine whether to apply the policy to the UE (e.g., whether to update the network slice of the UE) as in step 441.

In step 461, the AMF may transmit a registration accept message to the UE.

The registration accept message may carry slicing-related information related to at least one of RAN slicing, network slicing, slice group, or priority for the UE received by the AMF from the PCF. In an embodiment, the registration accept message may include information (e.g., slicing-related information) related to RAN slicing and/or priority determined by the network or allowed by the network to the UE for at least one of RAN slicing, network slicing, slice group, or priority requested by the UE. In an embodiment, the AMF may transmit information (e.g., an IE, a parameter, or an indication) about whether the AMF supports a function for at least one of RAN slicing, network slicing, slice group, or priority to the UE through the registration accept message.

In an embodiment, the network entity may inform the UE of information about whether the network entity supports a function related to slice group and/or slice priority. When the function is not supported, the UE may operate using configured NSSAI or allowed NSSAI.

The information about the function of the network may be provided to the UE using, e.g., the 5GS network feature support IE in an embodiment. The information about the function of the network may be provided to the UE using the slice group support indication in an embodiment.

In an embodiment, the network entity may send slice group information to the UE.

In an embodiment, the slice group information may include the tracking area code (TAC), the slice group identity, slice information (e.g., NSSAI), and/or slice priority information. In this case, the identities of the slice group may be mapped to one TAC. Further, slice priority may be mapped to slice group. Grouped slices may be mapped for the slice group identity.

In an embodiment, slices may be identified by network slice selection assistance information (NSSAI). The single-network slice selection assistance information (S-NSSAI) may be used as an identifier for distinguishing slices. The slicing-related information may include a slice type and a slice differentiator. The slice type may be used to distinguish whether slice supports eMBB or URLLC. The slice differentiator may be used to further subdivide the slice in slice type. For example, in relation to URLLC, the slice differentiator may indicate whether the slice is for the surgical robot or for factory automation.

In various embodiments, the slice group information may be configured as shown in Tables 1 to 9 below.

In an embodiment, the message sent by the AMF to the UE may include 5GS tracking area identity-slice group list information as shown in Tables 1 to 4. The information may include TAC information and slice group list information. The TAC information may be coded in various forms (e.g., partial tracking area identity, a combination of mobile country code (MCC) and mobile network code (MNC), or TAC) for efficiency, as shown in Tables 2 to 4.

In an embodiment, the slice group list information may be configured for the configured slice group or the allowed slice group as shown in Table 6 and transferred from the network entity to the UE.

The slice group list information of Table 6 may include a plurality of pieces of network slice information (e.g., S-NSSAI value or S-NSSAI information), and the network slice information may be configured as shown in Table 7, for example. In an embodiment, the S-NSSAI information may include at least one of the slice/service type (SST), the service differentiator or slice differentiator (SD), the mapped home public land mobile network (HPLMN) SST, or the mapped HPLMN SD.

In an embodiment, the slice group list information may be configured as shown in Table 8 for the rejected slice group and transferred from the network entity to the UE. In an embodiment, the slice group list information for the rejected slice group may include a list of rejected NSSAIs that may be configured as shown in Table 9. In an embodiment, the rejected NSSAI may include a cause value indicating the reason why the network slice is rejected, as shown in Table 10.

Table 1 shows the configuration of the 5GS tracking area identity-slice group list IE according to an embodiment.

TABLE 1

| | | | | | | | |
|---|---|---|---|---|---|---|---|
| 8 | 7 | 6 | 5 | 4 | 3 | 2 | 1 |

5GS tracking area identity- slice group list IEI
Length of 5GS tracking area identity - slice group list contents
Partial tracking area identity-slice group list 1
Partial tracking area identity-slice group list 2
. . .
Partial tracking area identity- slice group list p

Table 2 shows the configuration of the tracing area identity-slice group list IE according to an embodiment.

TABLE 2

| | | | | | | | |
|---|---|---|---|---|---|---|---|
| 8 | 7 | 6 | 5 | 4 | 3 | 2 | 1 |

| | | |
|---|---|---|
| 0 Spare | Type of list | Number of elements |

| | |
|---|---|
| MCC digit 2 | MCC digit 1 |
| MNC digit 3 | MCC digit 3 |
| MNC digit 2 | MNC digit 1 |

TAC 1
TAC 1 (continued)
TAC 1 (continued)
Slice group list IE
. . .
. . .
TAC k
TAC k (continued)
TAC k (continued)
Slice group list IE

Table 3 shows the configuration of the tracing area identity-slice group list IE according to an embodiment.

TABLE 3

| | | | | | | | |
|---|---|---|---|---|---|---|---|
| 8 | 7 | 6 | 5 | 4 | 3 | 2 | 1 |

| | | |
|---|---|---|
| 0 Spare | Type of list | Number of elements |

| | |
|---|---|
| MCC digit 2 | MCC digit 1 |
| MNC digit 3 | MCC digit 3 |
| MNC digit 2 | MNC digit 1 |

TAC 1
TAC 1 (continued)
TAC 1 (continued)
Slice group list IE

Table 4 shows the configuration of the tracing area identity-slice group list IE according to an embodiment.

TABLE 4

| | | | | | | | |
|---|---|---|---|---|---|---|---|
| 8 | 7 | 6 | 5 | 4 | 3 | 2 | 1 |

| | | |
|---|---|---|
| 0 Spare | Type of list | Number of elements |

| | |
|---|---|
| MCC digit 2 | MCC digit 1 |
| MNC digit 3 | MCC digit 3 |
| MNC digit 2 | MNC digit 1 |

TAC 1
TAC 1 (continued)
TAC 1 (continued)
Slice group list IE

| | |
|---|---|
| MCC digit 2 | MCC digit 1 |
| MNC digit 3 | MCC digit 3 |
| MNC digit 2 | MNC digit 1 |

TAC 2
TAC 2 (continued)
TAC 2 (continued)
Slice group list IE
. . .

| | |
|---|---|
| MCC digit 2 | MCC digit 1 |
| MNC digit 3 | MCC digit 3 |
| MNC digit 2 | MNC digit 1 |

TAC k
TAC k (continued)
TAC k (continued)
Slice group list IE

Table 5 shows the configuration of the slice group list IE according to an embodiment.

TABLE 5
8
Slice group list IEI
Length of slice group list contents
Slice group value 1
Slice group value 2
. . .
slice group value n

Table 6 shows the configuration of the slice group IE according to an embodiment.

TABLE 6
Slice group IEI
Length of Slice group contents
Slice group identity
Slice group priority
Number of NSSAI contents
S-NSSAI value 1
S-NSSAI value 2
. . .

Table 7 shows the configuration of the S-NSSAI IE according to an embodiment.

TABLE 7

| | | | | | | | |
|---|---|---|---|---|---|---|---|
| 8 | 7 | 6 | 5 | 4 | 3 | 2 | 1 |

S-NSSAI IEI
Length of S-NSSAI contents
SST
SD
Mapped HPLMN SST
Mapped HPLMN SD

Table 8 shows the configuration of the rejected slice group IE according to an embodiment.

TABLE 8
Rejected Slice group IEI
Length of Slice group contents
Slice group identity
Slice group priority
Number of rejected NSSAI contents
Rejected S-NSSAI value 1
Rejected S-NSSAI value 2
. . .

Table 9 shows the configuration of the rejected S-NSSAI IE according to an embodiment.

TABLE 9

| | | | | | | | |
|---|---|---|---|---|---|---|---|
| 8 | 7 | 6 | 5 | 4 | 3 | 2 | 1 |

| | |
|---|---|
| Rejected NSSAI IEI | octet 1 |
| Length of Rejected NSSAI contents | octet 2 |
| Rejected S-NSSAI 1 | octet 3 |
| | octet m |
| Rejected S-NSSAI 2 | octet m + 1* |
| | octet n* |
| . . . | octet n + 1* |
| | octet u* |
| Rejected S-NSSAI n | octet u + 1* |
| | octet v* |

Table 10 shows the configuration of the rejected S-NSSAI IE according to an embodiment.

TABLE 10

| | | | | | | | |
|---|---|---|---|---|---|---|---|
| 8 | 7 | 6 | 5 | 4 | 3 | 2 | 1 |

| | | |
|---|---|---|
| Length of rejected S-NSSAI | Cause value | octet 3 |

| SST | octet 4 |
|---|---|
| SD | octet 5* |
| | octet 7* |

In an embodiment, the slice group information may include at least one of TAC, slice group identity, NSSAI, or slice priority information.

In an embodiment, the slice group information may include the following information.

In an embodiment, the slice group information may include configured slice group information.

In this case, the NSSAI may be a configured NSSAI. The PLMN may configure one or more configured NSSAIs to the UE, and the UE may use the configured NSSAI as a default NSSAI. In this case, the slice group information may be the configured slice group IE. In an embodiment, when the network entity configures the configured slice group, the UE may select the slice in the configured slice group.

In an embodiment, the configuration slice group information may be transferred through a registration accept message, a configuration command message, or a service accept message.

In an embodiment, the slice group information may include allowed slice group information. In this case, the NSSAI may be an allowed NSSAI. The network entity may transmit, to the UE, an allowed NSSAI indicating a valid NSSAI for a registration area and/or a given access type. For the allowed NSSAI, the UE may establish a session in the network.

In this case, the slice group information may be an allowed slice group information element.

In an embodiment, the network entity may transmit a valid NSSAI for a registration area and/or a given access type to the UE through allowed slice group information. In an embodiment, the allowed slice group information may be included in a registration accept message, a configuration command message, or a service accept message and transferred.

In an embodiment, the slice group information may include rejected slice group information. In this case, the NSSAI may be rejected NSSAI. The rejected NSSAI is an NSSAI rejected in the PLMN or registration area. In this case, the slice group information may be a rejected slice group information element. The network entity may notify the UE of the rejected NSSAI(s) rejected in the PLMN or registration area through rejected slice group information.

In an embodiment, rejected slice group information may be included and transferred in a registration accept message, a configuration command message, a deregistration requested message, or a service accept message.

Upon receiving the message, the UE may store the reject slice group information, and then may not attempt to register the slice group received as the rejected slice group when intending to transmit the registration request or service request in the corresponding PLMN or the corresponding registration area.

In an embodiment, the message from the network to the UE may include a slice group deletion indication.

If the UE receives the slice group deletion indication, the UE may delete the previously received slice group information element.

In an embodiment, the registration accept message may include a slice group deletion indication.

In an embodiment, the service accept message may include a slice group deletion indication.

In an embodiment, the configuration command message may include a slice group deletion indication.

In an embodiment, the deregistration request message may include a slice group deletion indication.

In an embodiment, the deregistration request message may be a message initiated or triggered by the network.

In an embodiment, slice group timer information may be transmitted from the network to the UE.

In an embodiment, slice group-related information may be stored in the network. Further, the network may operate the timer in relation to the slice group and priority.

In an embodiment, when the timer is operated in relation to the slice group of the network, if the timer value expires, slice group-related information may be deleted according to the expiration of the timer value.

The slice group information and/or priority timer information transmitted from the network to the UE may be stored in the UE. If the timer expires according to the timer value according to the priority timer information, the UE may delete the information about the slice group in the UE. If the timer expires, the UE may delete slice group-related information stored in the UE.

In an embodiment, the message including slice group timer information among messages transmitted from the network to the UE may be as follows.

In an embodiment, the registration accept message may include a slice group timer.

In an embodiment, the service accept message may include a slice group timer.

In an embodiment, the configuration command message may include a slice group timer.

In an embodiment, the deregistration request message may include a slice group timer.

In an embodiment, the deregistration request message may be a message initiated or triggered by the network.

In an embodiment, slice group timer information may be transmitted from the network to the UE.

In an embodiment, slice group-related information may be stored in the network.

Alternatively, the network may operate the timer in relation to the slice group and priority.

In an embodiment, when the timer is operated in relation to the slice group of the network, if the timer value expires, slice group-related information may be deleted according to the expiration of the timer value.

In an embodiment, the slice group information and/or priority timer information transmitted from the network to the UE may be stored in the UE. If the timer expires according to the timer value, the UE may delete the information about the slice group in the UE. In other words, if the timer expires, slice group-related information stored in the UE may be deleted.

In an embodiment, the message including the slice group timer transmitted from the network to the UE may be as follows.

In an embodiment, the registration accept message may include a slice group timer.

In an embodiment, the service accept message may include a slice group timer.

In an embodiment, the configuration command message may include a slice group timer.

In an embodiment, the deregistration request message may include a slice group timer.

In an embodiment, the deregistration request message may be a message initiated or triggered by the network.

Upon receiving, from the network entity, information about at least one of RAN slicing, network slicing, slice group, or priority and information (e.g., an IE or indicator) about whether the network entity supports the function, the UE may store the information or update the information in step 471.

In an embodiment, the slice group information transmitted from the network entity to the UE may be stored in the UE.

The message including the slice group information may be as follows.

In an embodiment, the registration accept message may include slice group information.

In an embodiment, the service accept message may include slice group information.

In an embodiment, the configuration command message may include slice group information.

In an embodiment, the deregistration request message may include slice group information.

In an embodiment, the deregistration request message may be a message initiated or triggered by the network.

Thereafter, the AMF may verify the network slice group-related information.

In step 483, the AMF may set a timer related to the information.

In an embodiment, the network entity may transmit slice group timer information to the UE.

In an embodiment, the network entity may store slice group-related information.

In an embodiment, the network entity may operate a timer related to the slice group and/or the priority.

In an embodiment, when the timer related to the slice group of the network entity is operated, corresponding slice group-related information may be deleted when the timer expires.

In an embodiment, slice group information transmitted from the network entity to the UE and/or information about the timer (e.g., the slice group timer) related to priority may be stored in the UE. If the timer expires, the UE may delete the slice group information in the UE. When the timer expires, slice group-related information stored in the UE may be deleted.

In an embodiment, the message including information about the slice group timer transmitted from the network entity to the UE may be as follows.

In an embodiment, the registration accept message may include information about the slice group timer.

In an embodiment, the service accept message may include information about the slice group timer.

In an embodiment, the configuration command message may include information about the slice group timer.

In an embodiment, the deregistration request message may include information about the slice group timer.

In an embodiment, the deregistration request message may be initiated or triggered by the network entity.

In step 491, the AMF may send a configuration update command message to the UE. In an embodiment, the configuration update command message may include updated network slice (updated NS) information and/or timer information.

In an embodiment, the slicing-related information (e.g., slice group information and/or slice priority information) may be transferred from the network entity to the UE together with the NSSAI through the NAS message. The slicing-related information may include at least one of configured NSSAI, allowed NSSAI, or allowed group slice information. In an embodiment, the NAS message may be a registration accept message. In an embodiment, the NAS message may be a configuration command message. In an embodiment, the NAS message may be a service request message.

In an embodiment, the slicing-related information may be transferred to the lower layer, i.e., the AS layer, by the NAS layer of the UE.

In an embodiment, when the slicing-related information received by the UE does not match the previously stored slicing-related information, the UE may store a slice group and/or a slice priority indicated by the slicing-related information in the not-allowed slice information.

In an embodiment, the network entity may inform the UE of information about whether the network entity supports a function related to slice group and/or slice priority. When the function is not supported, the UE may operate using configured NSSAI or allowed NSSAI.

The information about the function of the network may be provided to the UE using, e.g., the 5GS network feature support IE in an embodiment. In an embodiment, the information about the function of the network may be provided to the UE using the slice group support indication in an embodiment.

In an embodiment, the network entity may send slice group information to the UE.

In an embodiment, the slice group information may include at least one of the tracking area code (TAC), the slice group identity, slice information (e.g., NSSAI), or slice priority information. In an embodiment, the identities of the slice group may be mapped to one TAC. In an embodiment, slice priority may be mapped to slice group.

Information about the slices may be grouped and mapped to the slice group identity.

In an embodiment, slices may be identified by network slice selection assistance information (NSSAI). In other words, the single-network slice selection assistance information (S-NSSAI) is used as an identifier for distinguishing slices, and slice-related information includes a slice type and a slice differentiator. The slice type may be used to distinguish whether slice supports eMBB or URLLC. The slice differentiator is used to further subdivide the slice compared to slice type. For example, for URLLC, the slice differentiator may distinguish whether the slice is for the surgical robot or for factory automation.

In an embodiment, referring to Tables 1 to 9, the slice group information may be configured as follows.

In an embodiment, the message sent by the AMF to the UE may include 5GS tracking area identity-slice group list information configurable as shown in Tables 1 to 4. The information may include TAC information and slice group list information. In an embodiment, the TAC information may be coded in various forms for efficiency as shown in Table 2 to Table 4.

In an embodiment, the slice group list information may be transferred from the network entity to the UE as shown in Table 6, in the case of the configured slice group or the allowed slice group.

In an embodiment, the slice group of Table 6 may include multiple network slice information, and such network slices may be configured as in Table 7.

In an embodiment, the slice group list information may be configured as shown in Table 8 and transferred from the network entity to the UE in the case of the rejected slice group. In the case of the rejected slice group, the slice group list information may include a list of rejected NSSAIs as shown in Table 9, and in an embodiment, the rejected NSSAI may include a cause value indicating the reason why the network slice is rejected as shown in Table 10.

In an embodiment, the information element, slice group information, may include at least one of TAC, slice group identity, NSSAI, or slice priority information.

In an embodiment, the slice group information may be configured slice group information. In this case, the NSSAI may be a configured NSSAI. The PLMN may configure one or more configured NSSAIs to the UE, and the UE may use the configured NSSAI as a default NSSAI. In this case, the slice group information may be a configured slice group information element. In an embodiment, when the network configures the configured slice group, the UE may select the slice in the configured slice group.

In an embodiment, the configuration slice group information may be transferred through a registration accept message, a configuration command message, or a service accept message.

In an embodiment, the slice group information may include allowed slice group information. In this case, the NSSAI may be an allowed NSSAI. The network entity may transmit, to the UE, allowed NSSAI(s) indicating the valid NSSAI for the registration area and/or the given access type, and the UE may establish a session in the network for such the allowed NSSAI. In an embodiment, the slice group information may be an allowed slice group IE.

In an embodiment, the network entity may transmit allowed slice group information indicating valid NSSAI(s) for the registration area and/or the given access type to the UE.

In an embodiment, the allowed slice group information may be included in a registration accept message, a configuration command message, or a service accept message and transferred.

In an embodiment, the slice group information may include rejected slice group information. In this case, the NSSAI may be rejected NSSAI. The rejected NSSAI may indicate the NSSAI rejected in the PLMN or registration area. In this case, the slice group information may be a rejected slice group information element. The network entity may transmit rejected slice group information including the rejected NSSAI(s) in the PLMN or registration area to the UE.

In an embodiment, rejected slice group information may be included and transferred in a registration accept message, a configuration command message, a deregistration requested message, or a service accept message.

Upon receiving the message, the UE may store the rejected slice group information, and then may not attempt to register the slice group received as the rejected slice group when intending to transmit the registration request or service request in the corresponding PLMN or the corresponding registration area.

In an embodiment, the message transmitted from the network to the UE may include a slice group deletion indication. If the UE receives the slice group deletion indication, the UE may delete the previously received slice group information element.

In an embodiment, the registration accept message may include a slice group deletion indication.

In an embodiment, the service accept message may include a slice group deletion indication.

In an embodiment, the configuration command message may include a slice group deletion indication.

In an embodiment, the deregistration request message may include a slice group deletion indication.

In an embodiment, the deregistration request message may be initiated or triggered by the network.

In step 493, the UE may store updated network slice (‘updated NS’) information and/or timer information received from the network.

In an embodiment, slice group information transmitted from the network to the UE may be stored in the UE.

In an embodiment, the registration accept message may include slice group information.

In an embodiment, the service accept message may include slice group information.

In an embodiment, the configuration command message may include slice group information.

In an embodiment, the deregistration request message may include slice group information.

In an embodiment, the deregistration request message may be initiated or triggered by the network.

In step 495, the UE may send a configuration update complete message to the AMF.

In an embodiment, the UE may inform the network entity (e.g., the AMF) of information about whether the UE supports the function related to the slice group and/or slice priority. When the UE receives information about not supporting the function, the network entity may not provide the function to the UE even if the function is supported.

In an embodiment, the UE may transmit, to the network (e.g., the AMF or the SMF), whether to support the function using the slice group support indication IE. In an embodiment, the UE may transfer the priority information together with whether to support the AS slice network slicing, to the network using the 5GMM capability information IE.

In an embodiment, when the timer expires based on the timer information, the UE may delete updated slicing-related information stored in the UE.

Thereafter, the network entity (e.g., AMF) may update the slicing-related information.

In an embodiment, the slice group may include grouped slices. Slice grouping may be done according to the operator's policy.

In an embodiment, the operator's policy may give higher priority to the user who pays higher usage fees, based on the usage fees paid by the users. For example, if 1 has the highest priority in the order of 1, 2, and 3, priority 1 may be given to the group having the highest priority.

In an embodiment, the operator's policy may distinguish slice types such as URLLC or eMBB, and may differentially set priority according to the slice type.

For example, when ultra reliable low latency communications (URLLC) slices are grouped, a high priority may be given to a slice requiring temporal reliability.

For example, when a short latency is critical, a high priority may be given to a slice requiring a short latency.

For example, when eMBB slices are grouped, if a higher priority is given to the one requiring a large amount of data when grouping the eMBB slices, a high priority may be given to the group of the slices.

In an embodiment, grouping of network slices may be performed by the AMF.

In an embodiment, the AMF may determine allowed slice group information, configured slice group information, and/or rejected slice group information by grouping the allowed NSSAI, configured NSSAI, and/or rejected NSSAI, based on the S-NSSAI information and the operator's policy received from the gNB, and may transmit the same to the UE.

In an embodiment, the grouping of the network slice may be performed by the gNB. The gNB may create an allowed slice group based on the allowed slice information received from the AMF, i.e., the allowed NSSAI.

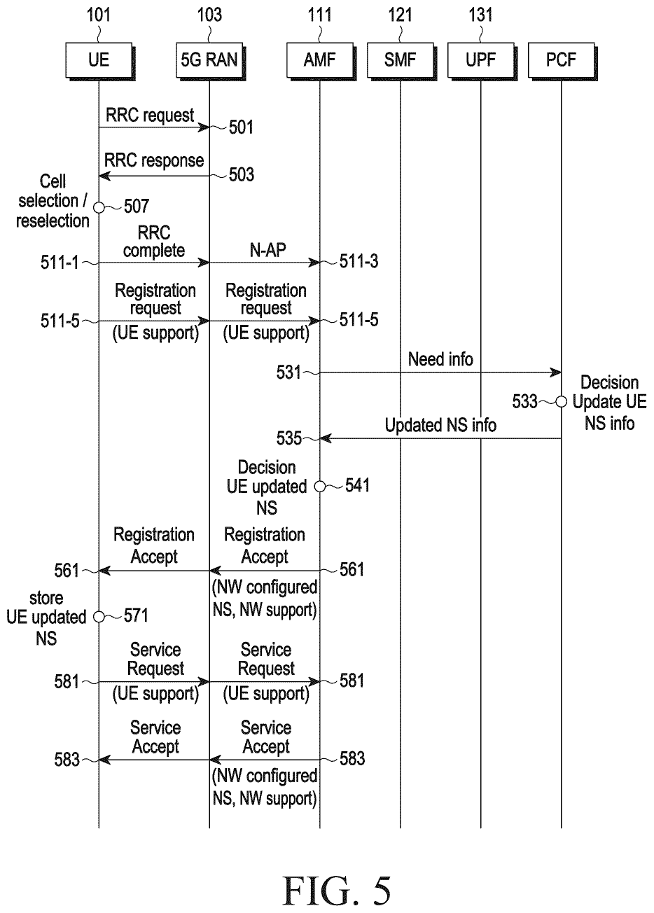

FIG. 5 is a flowchart illustrating a procedure of efficiently supporting a network slice in a 5G network environment according to an embodiment of the disclosure. In various embodiments, at least one of operations (e.g., steps) to be described below may be omitted, modified, or reordered.

Referring to FIG. 5, in step 501, the UE (e.g., the UE 101) may send an RRC request to a 5G RAN (e.g., the 5G RAN 103).

In step 503, the 5G RAN may send an RRC response to the UE. In an embodiment, slicing-related information (e.g., slice group information and/or slice priority information) may be transferred through the RRC response message of the AS layer.

In step 507, the UE may perform cell selection or cell reselection based on the slicing-related information.

If the UE previously connects to the network and receives information related to the slice group and/or slice priority through a NAS message, the information may be used for cell reselection of the AS layer of the UE.

In an embodiment, slice group/slice priority information transmitted and stored in the UE through the NAS message may be used as follows.

The information may be used to reselect a suitable cell to be accessed by the UE in the AS layer. In other words, when both the network and the UE support a slice group and there are a slice group priority and a slice group priority, the UE may make the selection with priority to the cell having high slice group priority based on the corresponding information, in cell reselection and cell search.

In an embodiment, when the UE has a PDU session as it is performing communication, the UE may use the information to configure slice group information in a UL NAS transport message used to transmit a session management message to the NAS layer.

In an embodiment, the information may be used to select a requested slice group when the UE transmits a registration request message or the UE transmits a service request message.

In an embodiment, the AS layer of the UE may select a RAN slice based on the slice group and/or slice priority indicated by the slicing-related information. In step 511-1, the UE may send an RRC complete to the 5G RAN.

In step 511-3, the 5G RAN may send an N1-AP message to an AMF (e.g., the AMF 111).

In step 511-5, the UE may send a registration request to the AMF. In an embodiment, the registration request message may include at least one of indication about whether the UE supports RAN slicing, whether the UE supports the RAN slicing group, whether the UE requests priority in the RAN slicing, or whether the UE supports the above-described function and be transferred to the AMF.

In an embodiment, the slicing-related information (e.g., slice group information and/or slice priority information) may be transferred from the network entity to the UE together with the NSSAI through the NAS message.

The slicing-related information may include at least one of configured NSSAI, allowed NSSAI, or allowed group slice information. The NAS message may be the registration accept message of step 561 in an embodiment. In an embodiment, the NAS message may be a configuration command message. In an embodiment, the NAS message may be a service request message.

In an embodiment, the slicing-related information may be transferred to the lower layer, i.e., the AS layer, by the NAS layer of the UE.

In an embodiment, when the slicing-related information received by the UE does not match the previously stored slicing-related information, the UE may store a slice group and/or a slice priority indicated by the slicing-related information in the not-allowed slice information.

In an embodiment, the UE may inform the network whether the UE supports a function related to the slice group and/or slice priority. When the UE receives information about not supporting the function, the network may not provide the function to the UE even if the function is supported.

In an embodiment, the UE may transmit, to the network (e.g., the AMF or the SMF), whether to support the function using the slice group support indication IE. In an embodiment, the UE may transfer the priority information together with whether to support the AS slice network slicing, to the network using the 5GMM capability information IE.

Thereafter, the AMF may verify the information received from the UE.

In step 531, the AMF may request, from the PCF, at least one of RAN slicing information, network slicing information, slice group information, or priority information related to the UE.

In step 533, the PCF may determine a policy for at least one of RAN slicing, network slicing, slice group, or priority in relation to the UE.

In step 535, the PCF may transmit policy information for at least one of RAN slicing, network slicing, slice group, or priority for the UE to the AMF. Through the policy information, the AMF may update information about at least one of RAN slicing, network slicing, slice group, or priority that it has for UE. In an embodiment, since it is the AMF which applies the policy to the UE, the AMF may determine whether to apply the policy to the UE (e.g., whether to update the network slice of the UE) as in step 541.

In step 561, the AMF may transmit a registration accept message to the UE.

In an embodiment, the registration accept message may carry slicing-related information related to at least one of RAN slicing, network slicing, slice group, or priority for the UE received by the AMF from the PCF. In an embodiment, the registration accept message may include information (e.g., slicing-related information) related to RAN slicing and/or priority determined by the network or allowed by the network to the UE for at least one of RAN slicing, network slicing, slice group, or priority requested by the UE. In an embodiment, the AMF may transmit information (e.g., an IE, a parameter, or an indication) about whether the AMF supports a function for at least one of RAN slicing, network slicing, slice group, or priority to the UE through the registration accept message.

In an embodiment, the network may inform the UE whether the network supports a function related to slice group and/or slice priority. When the function is not supported, the UE may operate using configured NSSAI or allowed NSSAI.

The information about the function of the network may be provided to the UE using, e.g., the 5GS network feature support IE in an embodiment. The information about the function of the network may be provided to the UE using the slice group support indication in an embodiment.

Upon receiving, from the network entity, information about at least one of RAN slicing, network slicing, slice group, or priority and information (e.g., an IE or indicator) about whether the network supports the function, the UE may store the information or update the information in step 571.

In step 581, the UE may send a service request message to the AMF.

In an embodiment, the slicing-related information (e.g., slice group information and/or slice priority information) may be transferred from the network entity to the UE together with the NSSAI through the NAS message. The slicing-related information may include at least one of configured NSSAI, allowed NSSAI, or allowed group slice information.

In an embodiment, the slicing-related information may be transferred to the lower layer, i.e., the AS layer, by the NAS layer of the UE.

In an embodiment, the UE may inform the network entity whether the UE supports a function related to slice group and/or slice priority. When the UE receives information about not supporting the function, the network may not provide the function to the UE even if the function is supported.

In an embodiment, the UE may transmit, to the network (e.g., the AMF or the SMF), whether to support the function using the slice network slicing indication IE. In another embodiment, the UE may transfer the priority information together with whether to support the slice group, to the network using the 5GMM capability information IE.

In an embodiment, slice group information may be included in the service request message. The slice group information may include at least one of the tracking area code (TAC), the slice group identity, slice information (NSSAI), or slice priority. In this case, the identities of the slice group may be mapped to one TAC. Further, slice priority may be mapped to slice group.

In an embodiment, information about the slices may be grouped and mapped to the slice group identity.

In an embodiment, slices may be identified by network slice selection assistance information (NSSAI). In other words, the single-network slice selection assistance information (S-NSSAI) is used as an identifier for distinguishing slices, and slice-related information includes a slice type and a slice differentiator. The slice type may be used to distinguish whether slice supports eMBB or URLLC. The slice differentiator may be used to further subdivide the slice compared to slice type. For example, for URLLC, the slice differentiator may distinguish whether the slice is for the surgical robot or for factory automation.

In an embodiment, the information element, slice group information, may include at least one of TAC, slice group identity, NSSAI, or slice priority information. The slice group information may include the following information.

In an embodiment, the slice group information may include requested slice group information. In this case, the NSSAI may be a requested NSSAI. The UE may select a requested NSSAI from a configured NSSAI or an allowed NSSAI. In this case, the slice group information may be a requested slice group information element. Therefore, the UE may select the requested slice group from the configured slice group or the allowed slice group.

In an embodiment, the requested slice group information may be included and transferred in a registration request message or a service request message.

If the UE previously connects to the network and receives slice group/slice priority information through a NAS message, the information may be used for cell reselection in the AS layer of the UE.

In an embodiment, slice group/slice priority information stored in the UE through the NAS message may be used as follows.

In an embodiment, the information may be used to reselect a suitable cell to be accessed by the UE in the AS layer. In other words, when both the network and the UE support a slice group and there are a slice group priority and a slice group priority, the UE may make the selection with priority to the cell having high slice group priority based on the corresponding information, in cell reselection and cell search.

In an embodiment, when the UE has a PDU session as it is performing communication, the information may be used to configure slice group information in a UL NAS transport message used to transmit a session management message to the NAS layer.

In an embodiment, the information may be used to select a requested slice group when the UE transmits a registration request message or the UE transmits a service request message.

In an embodiment, when the network has slice group/priority information about the UE, the network (e.g., the AMF) may send a deregistration request message to attempt to delete the slice group information stored in the UE.

In an embodiment, when the slice group information and/or the slice priority information expires, is deleted, or is absent, the UE may request the slice group information/slice priority information from the network.

In an embodiment, the UE may request slice group information or slice priority information even when the registration area is changed or the tracking area is changed. The information for the request may be transferred through the ‘slice group information requested’ IE. At least one bit of the ‘slice group information requested’ IE may be set to ‘l’ and transferred to the network. For UEs capable of supporting slice grouping, the at least one bit may be ‘l’ by default.

In an embodiment, the message including the ‘slice group information requested’ IE may be a registration request message. In an embodiment, the message including the ‘slice group information requested’ IE may be a service request message.

In step 583, the AMF may send a service accept message to the UE. In an embodiment, the service accept message may include updated network slice (updated NS) information and/or timer information.

In an embodiment, the network may inform the UE whether the network supports a function related to slice group and/or slice priority. When the function is not supported, the UE may operate using configured NSSAI or allowed NSSAI.

The information about the function of the network may be provided to the UE using, e.g., the 5GS network feature support IE in an embodiment. In an embodiment, the information about the function of the network may be provided to the UE using the slice group support indication in an embodiment.

In an embodiment, when the slicing-related information received by the UE does not match the previously stored slicing-related information, the UE may store a slice group and/or a slice priority indicated by the received slicing-related information in the not-allowed slice information.

In an embodiment, the network may send slice group information to the UE. The slice group information may include at least one of the tracking area code (TAC), the slice group identity, slice information (NSSAI), or slice priority information. In this case, the identities of the slice group may be mapped to one TAC. Further, slice priority may be mapped to slice group.

Information about the slices may be grouped and mapped to the slice group identity.

In an embodiment, slices may be identified by network slice selection assistance information (NSSAI). In other words, the single-network slice selection assistance information (S-NSSAI) is used as an identifier for distinguishing slices, and slice-related information includes a slice type and a slice differentiator. The slice type may be used to distinguish whether slice supports eMBB or URLLC. The slice differentiator may be used to further subdivide the slice compared to slice type. For example, for URLLC, the slice differentiator may distinguish whether the slice is for the surgical robot or for factory automation.

In an embodiment, the slice group information may be configured referring to Tables 1 to 9.

In an embodiment, the message that AMF sends to the UE transmits 5GS tracking area identity-slice group list information as shown in Table 1 to Table 4. The information includes TAC information and slice group list information. The TAC information may be coded in various forms for efficiency as shown in Table 2 to Table 4.

In an embodiment, the slice group list information may be configured for the configured slice group or the allowed slice group as shown in Table 6 and transferred from the network entity to the UE.

The slice group of Table 6 may include multiple network slice information and, as an example, the network slice information may be configured as in Table 7.

In an embodiment, the slice group list information may be configured as shown in Table 8 for the rejected slice group and transferred from the network entity to the UE. In the case of the rejected slice group, it may include a list of rejected NSSAIs as shown in Table 9, and the rejected NSSAI may include the reason (cause value) why the network slice is rejected as shown in Table 10.

In an embodiment, the information element, slice group information, may include at least one of TAC, slice group identity, NSSAI, or slice priority information. The slice group information may include the following information.

In an embodiment, the slice group information may include configured slice group information. In this case, the NSSAI may be a configured NSSAI. The PLMN may configure one or more configured NSSAIs to the UE, and the UE may use the configured NSSAI as a default NSSAI. In this case, the slice group information may be a configured slice group information element. In an embodiment, when the network configures the configured slice group, the UE may select the slice in the configured slice group.

In an embodiment, the configuration slice group information may be included and transferred in a registration accept message, a configuration command message, or a service accept message.

In an embodiment, the slice group information may include allowed slice group information. In this case, the NSSAI may be an allowed NSSAI. The network may transmit the valid NSSAI in the registration area, given access type to the UE through the allowed NSSAI and, for the allowed NSSAI, the UE may establish a session in the network.

In an embodiment, the slice group information may include an allowed slice group information element.

In an embodiment, the network may transmit a valid NSSAI in the registration area and the given access type to the UE through allowed slice group information.

In an embodiment, the allowed slice group information may be included and transferred in a registration accept message, a configuration command message, or a service accept message.

In an embodiment, the slice group information may include rejected slice group information. In this case, the NSSAI may be rejected NSSAI. The rejected NSSAI is an NSSAI rejected in the PLMN or registration area. In this case, the slice group information may be a rejected slice group information element. The network may notify the UE of the NSSAI rejected in the PLMN or registration area through rejected slice group information.

In an embodiment, rejected slice group information may be included and transferred in a registration accept message, a configuration command message, a deregistration requested message, or a service accept message.

In an embodiment, upon receiving the message, the UE may store the rejected slice group information, and then may not attempt to register the slice group received as the rejected slice group when intending to transmit the registration request or service request in the corresponding PLMN or the corresponding registration area.

In an embodiment, the message from the network to the UE may include a slice group deletion indication. If the UE receives the slice group deletion indication, the UE may delete the previously received slice group information element.

In an embodiment, the registration accept message may include a slice group deletion indication.

In an embodiment, the service accept message may include a slice group deletion indication.

In an embodiment, the configuration command message may include a slice group deletion indication.

In an embodiment, the deregistration request message may include a slice group deletion indication.

In an embodiment, the deregistration request message may be a message initiated or triggered by the network.

In an embodiment, the slice group information from the network to the UE may be stored in the UE.

In an embodiment, the registration accept message may include slice group information.

In an embodiment, the service accept message may include slice group information.

In an embodiment, the configuration command message may include slice group information.

In an embodiment, the deregistration request message may include slice group information.

In an embodiment, the deregistration request message may be a message initiated or triggered by the network.

In an embodiment, slice group timer information may be transmitted from the network to the UE.

In an embodiment, slice group-related information may be stored in the network.

In an embodiment, the network may operate the timer in relation to the slice group and priority.

When the timer is operated in relation to the slice group of the network, if the timer value expires, slice group-related information may be deleted according to the expiration of the timer value.

In an embodiment, the slice group information and priority timer information transmitted from the network to the UE may be stored in the UE. If the timer expires according to the timer value determined according to the priority timer information, the UE may delete the information about the slice group in the UE. In other words, if the timer expires, slice group-related information stored in the UE may be deleted.

In an embodiment, the message transmitted from the network to the UE may include a slice group timer.

In an embodiment, the registration accept message may include a slice group timer.

In an embodiment, the service accept message may include a slice group timer.

In an embodiment, the configuration command message may include a slice group timer.

In an embodiment, the deregistration request message may include a slice group timer.

In an embodiment, the deregistration request message may be a message initiated or triggered by the network.

In an embodiment, the UE may store updated network slice (updated NS) information and/or timer information received from the network.

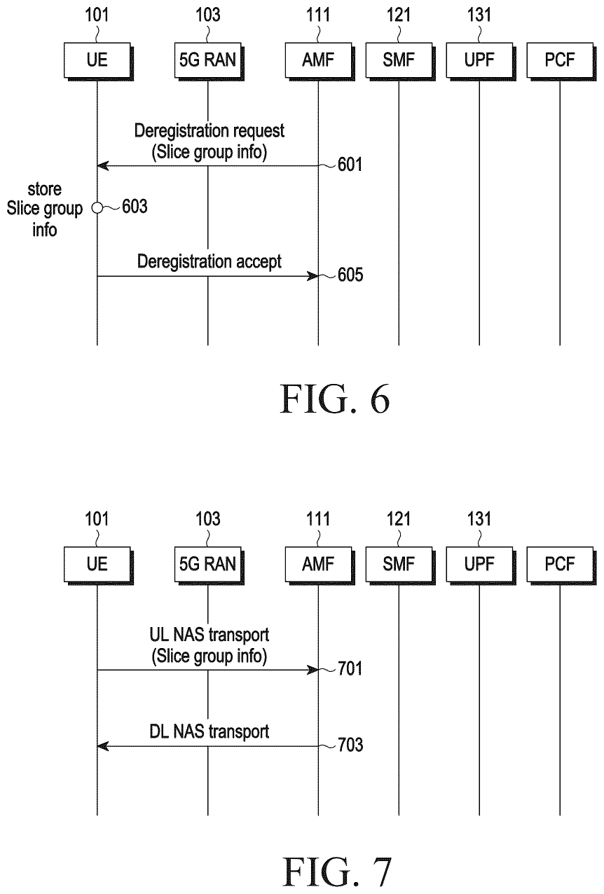

FIG. 6 is a flowchart illustrating a deregistration procedure of supporting a network slice in a 5G network environment according to an embodiment of the disclosure.

Referring to FIG. 6, in process 601, the AMF sends a deregistration request message to the UE.

In an embodiment, if the UE previously connects to the network and receives slice group/slice priority information through a NAS message, the information may be used for cell reselection in the AS layer. (e.g., see process 461 of FIG. 4)

In an embodiment, slice group/slice priority information stored in the UE through the NAS message may be used as follows.

In an embodiment, the information may be used to reselect a suitable cell to be accessed by the UE in the AS layer. In other words, when both the network and the UE support a slice group and there are a slice group priority and a slice group priority, the UE may make the selection with priority to the cell having high slice group priority based on the corresponding information, in cell reselection and cell search.

In an embodiment, when the UE has a PDU session as it is performing communication, the information may be used to configure slice group information in a UL NAS transport message used to transmit a session management message to the NAS layer.

In an embodiment, the information may be used to select a requested slice group when the UE transmits a registration request message or the UE transmits a service request message.

In an embodiment, when the network has slice group/priority information about the UE, the network (e.g., the AMF) may send a deregistration request message to attempt to delete the slice group information stored in the UE.

In an embodiment, the network may send slice group information to the UE. The slice group information may include at least one of the tracking area code (TAC), the slice group identity, slice information (NSSAI), or slice priority information. In this case, the identities of the slice group may be mapped to one TAC. Further, slice priority may be mapped to slice group.

In an embodiment, information about the slices may be grouped and mapped to the slice group identity.

In an embodiment, slices may be identified by network slice selection assistance information (NSSAI). In other words, the single-network slice selection assistance information (S-NSSAI) is used as an identifier for distinguishing slices, and slice-related information includes a slice type and a slice differentiator. The slice type may be used to distinguish whether slice supports eMBB or URLLC. The slice differentiator may be used to further subdivide the slice compared to slice type. For example, for URLLC, the slice differentiator may distinguish whether the slice is for the surgical robot or for factory automation.

In an embodiment, the information element, slice group information, may include at least one of TAC, slice group identity, NSSAI, or slice priority information.

In an embodiment, the slice group information may include rejected slice group information. In this case, the NSSAI may be rejected NSSAI. The rejected NSSAI is an NSSAI rejected in the PLMN or registration area. In this case, the slice group information may be a rejected slice group information element. The network may notify the UE of the NSSAI rejected in the PLMN or registration area through rejected slice group information.

In an embodiment, rejected slice group information may be included and transferred in a registration accept message, a configuration command message, a deregistration requested message, or a service accept message.

Upon receiving the message, the UE may store the rejected slice group information, and then may not attempt to register the slice group received as the rejected slice group when intending to transmit the registration request or service request in the corresponding PLMN or the corresponding registration area.

In an embodiment, the message from the network to the UE may include a slice group deletion indication.

If the UE receives the slice group deletion indication, the UE may delete the previously received slice group information element.

In an embodiment, the registration accept message may include a slice group deletion indication.

In an embodiment, the service accept message may include a slice group deletion indication.

In an embodiment, the configuration command message may include a slice group deletion indication.

In an embodiment, the deregistration request message may include a slice group deletion indication.

In an embodiment, the deregistration request message may be a message initiated or triggered by the network.

In process 603, the UE may store slice group information.

In an embodiment, the slice group information from the network to the UE may be stored in the UE.

In an embodiment, the registration accept message may include slice group information.

In an embodiment, the service accept message may include slice group information.

In an embodiment, the configuration command message may include slice group information.

In an embodiment, the deregistration request message may include slice group information.

In an embodiment, the deregistration request message may be a message initiated or triggered by the network.

In process 605, the UE may transmit a deregistration accept message to the AMF.

FIG. 7 is a flowchart illustrating a NAS transport procedure of supporting a network slice in a 5G network environment according to an embodiment of the disclosure.

Referring to FIG. 7, in process 701, the UE may send a UL NAS transport message to the AMF.

In an embodiment, the network may send slice group information to the UE. The slice group information may include at least one of the tracking area code (TAC), the slice group identity, slice information (NSSAI), or slice priority information. In this case, the identities of the slice group may be mapped to one TAC. Further, slice priority may be mapped to slice group.

In an embodiment, information about the slices may be grouped and mapped to the slice group identity.

In an embodiment, slices may be identified by network slice selection assistance information (NSSAI). In other words, the single-network slice selection assistance information (S-NSSAI) is used as an identifier for distinguishing slices, and slice-related information includes a slice type and a slice differentiator. The slice type may be used to distinguish whether slice supports eMBB or URLLC. The slice differentiator may be used to further subdivide the slice compared to slice type. For example, in URLLC, the slice differentiator may distinguish whether the slice is for the surgical robot or for factory automation.

In an embodiment, the information element, slice group information, may include at least one of TAC, slice group identity, NSSAI, or slice priority information.

In an embodiment, the slice group information may include the most general slice group information. In an embodiment, the slice group information may be included and transferred in a UL NAS transport message.

In an embodiment, when the request type is initial request, existing PDU session, or MA PDU request, or when the payload container type IE is N1 SM information and the UE is not registered for SNPN onboarding, the UE may include the slice group information to use the slice group information known to the UE or transmit a session-related message.

In an embodiment, if the UE previously connects to the network and receives slice group/slice priority information through a NAS message, the information may be used for cell reselection in the AS layer.

In an embodiment, slice group/slice priority information stored in the UE through the NAS message may be used as follows.

In an embodiment, the information may be used to reselect a suitable cell to be accessed by the UE in the AS layer. In other words, when both the network and the UE support a slice group and there are a slice group priority and a slice group priority, the UE may make the selection with priority to the cell having high slice group priority based on the corresponding information, in cell reselection and cell search.

In an embodiment, when the UE has a PDU session as it is performing communication, the information may be used to configure slice group information in a UL NAS transport message used to transmit a session management message to the NAS layer.

In an embodiment, the information may be used to select a requested slice group when the UE transmits a registration request message or the UE transmits a service request message.

In an embodiment, when the network has slice group/priority information about the UE, the network (e.g., the AMF) may send a deregistration request message to attempt to delete the slice group information stored in the UE.

In process 703, the AMF may transmit a DL NAS transport message to the UE. In an embodiment, when a session management message is transmitted from the network entity to the UE, the session management message may be included and transmitted in the DL NAS transport message.

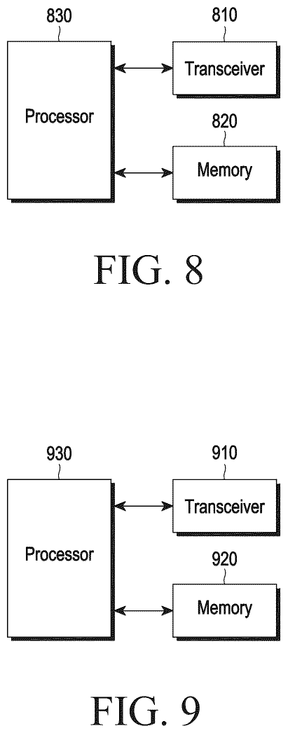

FIG. 8 is a view illustrating a configuration of a UE according to an embodiment.

As shown in FIG. 8, a UE (e.g., the UE 101) may include a transceiver 810, memory 820, and a processor 830. The processor 830, transceiver 810, and memory 820 of the UE may operate according to the above-described communication methods by the UE. However, the components of the UE are not limited thereto. For example, the UE may include more or fewer components than the above-described components. Further, at least one of the processor 830, the transceiver 810, and the memory 820 may be implemented in the form of a single chip.

The transceiver 810 collectively refers to the transmitter of the UE and the receiver of the UE and may transmit and receive signals to/from the base station or network entity. The signals transmitted/received with the base station may include control information and data. To that end, the transceiver 810 may include an RF transmitter for frequency-up converting and amplifying signals transmitted and an RF receiver for low-noise amplifying signals received and frequency-down converting the frequency of the received signals. However, this is merely an example of the transceiver 810, and the components of the transceiver 810 are not limited to the RF transmitter and the RF receiver.

The transceiver 810 may include a wired/wireless transceiver and may include various components for transmitting/receiving signals.

The transceiver 810 may receive signals via a radio channel, output the signals to the processor 830, and transmit signals output from the processor 830 via a radio channel.

The transceiver 810 may receive and output communication signals to the processor and transmit the signals output from the processor to a network entity (e.g., the RAN 103, the AMF 111, or the SMF 121) through a wired/wireless network.

The memory 820 may store programs and data necessary for the operation of the UE. The memory 820 may store control information or data that is included in the signal obtained by the UE. The memory 820 may include a storage medium, such as ROM, RAM, hard disk, CD-ROM, or DVD, or a combination of storage media.

The processor 830 may control a series of processes for the UE to be able to operate according to at least one of the above-described embodiments. The processor 830 may include at least one processor. For example, the processor 830 may include a communication processor (CP) that performs control for communication and an application processor (AP) that controls an upper layer, such as an application program.

FIG. 9 is a block diagram illustrating a configuration of a network entity according to an embodiment.

As shown in FIG. 9, a network entity of the disclosure (e.g., the 5G RAN 120, the AMF 111 or the SMF 121) may include a transceiver 910, memory 920, and a processor 930. The processor 930, transceiver 910, and memory 920 of the network entity may operate according to the above-described communication methods by the network entity. However, the components of the network entity are not limited thereto. For example, the network entity may include more or fewer components than the above-described components. The processor 930, the transceiver 910, and the memory 920 may be implemented in the form of a single chip. The network entity may include network functions (NFs), such as the access and mobility management function (AMF), session management function (SMF), policy and charging function (PCF), network exposure function (NEF), unified data management (UDM), and user plane function (UPF), as described above. The network entity may include a base station.

The transceiver 910 collectively refers to the receiver of the network entity and the transmitter of the network entity and may transmit and receive signals to/from a UE or another network entity. In this case, the signals transmitted/received with the base station may include control information and data. In an embodiment, the transceiver 910 may include an RF transmitter for frequency-up converting and amplifying signals transmitted and an RF receiver for low-noise amplifying signals received and frequency-down converting the frequency of the received signals. However, this is merely an example of the transceiver 910, and the components of the transceiver 910 are not limited to the RF transmitter and the RF receiver. The transceiver 910 may include a wired/wireless transceiver and may include various components for transmitting/receiving signals.

The transceiver 910 may receive signals via a communication channel (e.g., a radio channel), output the signals to the processor 930, and transmit signals output from the processor 930 via a radio channel.

The transceiver 910 may receive the communication signal and output it to the processor 930 and transmit the signal output from the processor 930 to the UE or another network entity through the wired/wireless network.

The memory 920 may store programs and data necessary for the operation of the network entity. The memory 920 may store control information or data that is included in the signal obtained by the network entity. The memory 920 may include a storage medium, such as ROM, RAM, hard disk, CD-ROM, or DVD, or a combination of storage media.

The processor 930 may control a series of processes for the network entity to be able to operate according to the above-described embodiments. The processor 930 may include at least one processor. The methods according to the embodiments described in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method for communication by a user equipment (UE) using network slicing, the method comprising:
transmitting a first non-access stratum (NAS) message to a network entity;
receiving, from the network entity, a second NAS message including slicing-related information related to a slice priority and an access stratum (AS) slice group; and
selecting a radio access network (RAN) slice in an AS layer using the slicing-related information.

2. The method of claim 1, wherein the second NAS message includes any one of a registration accept message, a configuration command, or a service request message.

3. The method of claim 1, wherein the slicing-related information includes at least one of a tracking area code (TAC), a slice group identifier of a slice group mapped to the MAC, or information about a slice group priority mapped to the slice group.

4. The method of claim 1, wherein the slicing-related information includes at least one of network slice selection assistance information (NSSAI) for identifying a network slice, a slice type, or a slice differentiator.

5. The method of claim 1, further comprising, when the received slicing-related information does not match pre-stored slicing-related information, storing an AS slice group and slice priority corresponding to the received slicing-related information as non-allowable slice information.

6. The method of claim 1, further comprising receiving, from the network entity, information indicating whether the network entity supports a function related to the AS slice group and/or slice priority.

7. The method of claim 1, further comprising transmitting, to the network entity, information indicating whether the UE supports a function related to the AS slice group and/or slice priority.

8. A method for communication by a network entity using network slicing, the method comprising:
receiving a first non-access stratum (NAS) message from a user equipment (UE); and
transmitting, to the UE, a second non-access stratum (NAS) message including slicing-related information related to a slice priority and an access stratum (AS) slice group, wherein the slicing-related information is used for the UE to select a radio access network (RAN) slice in an AS layer.

9. The method of claim 8, wherein the second NAS message includes any one of a registration accept message, a configuration command, or a service request message.

10. The method of claim 8, wherein the slicing-related information includes at least one of a tracking area code (TAC), a slice group identifier of a slice group mapped to the MAC, or information about a slice group priority mapped to the slice group.

11. The method of claim 8, wherein the slicing-related information includes at least one of network slice selection assistance information (NSSAI) for identifying a network slice, a slice type, or a slice differentiator.

12. The method of claim 8, further comprising, when the received slicing-related information does not match pre-stored slicing-related information, storing an AS slice group and slice priority corresponding to the received slicing-related information as non-allowable slice information.

13. The method of claim 8, further comprising receiving, from the network entity, information indicating whether the network entity supports a function related to the AS slice group and/or slice priority.

14. The method of claim 8, further comprising transmitting, to the network entity, information indicating whether the UE supports a function related to the AS slice group and/or slice priority.

15. A device supporting network slicing of a user equipment (UE), the UE comprising:
a transceiver; and
a processor configured to:
transmit a first non-access stratum (NAS) message to a network entity:
receive, from the network entity, a second NAS message including slicing-related information related to a slice priority and an access stratum (AS) slice group; and
select a radio access network (RAN) slice in an AS layer using the slicing-related information.
